(19) United States
(12) Patent Application Publication
(10) Pub. No.: US 2006/0056417 A1
(43) Pub. Date: Mar. 16, 2006

(54) Unique numbering for SONET/SDH timeslots in network management system applications

(76) Inventor: Saranagati Chatterjee, Santa Clara, CA (US)

Correspondence Address: Edward A. Pennington;Swidler Berlin Shereff Friedman, LLP, Suite 300, 3000 K Street, NW, Washington, DC, 20007-5116, US

(21) Appl. No.: 10/939,427

(22) Filed: Sep. 14, 2004

(51) Int. Cl. H04B 7/212; H04L 12/56

(52) U.S. Cl. 370/395.3; 370/442

(57) ABSTRACT

The capability is provided to select the timeslots for the SONET/SDH network elements so that the appropriate information is carried in the appropriate timeslots transparently and automatically, and without the user having to worry about the underlying protocol (SONET/SDH). A method of managing a telecommunications network comprises obtaining information relating to a physical termination point of the telecommunications network, obtaining information relating to a connection termination point of the telecommunications network, and generating a unique identifier for the connection termination point based on the obtained information relating to a physical termination point of the telecommunications network and the obtained information relating to a connection termination point of the telecommunications network.

### BACKGROUND OF THE INVENTION

1. Field of the Invention

The present invention relates to a system and method for automatically discovering network elements and mapping network topology of network inter-connections.

2. Description of the Related Art

As telecommunications services have proliferated, telecommunications networks have become increasingly complex. Today, telecommunications networks, using technologies such as Synchronous Optical Network (SONET), Dense Wavelength Division Multiplexing (DWDM), Asynchronous Transfer Mode (ATM), Ethernet, etc., may extend worldwide and may include thousands of network elements (NEs). Typically, systems known as Network Management Systems (NMSs) are used to manage the configuration and operation of such telecommunications networks.

In particular, NMSs have applications that use timeslots of a particular network facility to create cross-connects in a Network Element. Every timeslot is associated with a fixed Access Identifier (AID) at a particular timeslot rate. For a circuit spanning through SONET/SDH NEs, the creation of a circuit will involve the creation of Cross-connects in the respective SONET or SDH NE. The AIDs and the timeslot rate are different at SONET and SDH layers. When creating the cross-connects, the NMS must be aware of the kind of Network Element (SONET/SDH) or in some cases even the kind of facility (SONET/SDH).

Typically, an NMS may be configured to manage a network that includes both SONET and SDH NEs. Likewise, customers may have networks that span different types of NEs. For example, there may be a facility configured to carry SONET traffic in an SDH Network Element. Each NE has different facilities and each facility has its own logical timeslots. In a SONET NE, a SONET facility would have SONET timeslots based on the bandwidth of the facility. Likewise, an SDH facility would have SDH timeslots based on the bandwidth of the facility. The SONET and SDH timeslots are not inherently related to each other. Thus, problems arise when a facility, NE, or network includes both SONET and SDH protocols.

When creating connections for a user, the NMS automatically selects the available timeslots for each facility in the connection path. For a homogeneous network containing only SONET or only SDH Network Elements selecting timeslots is relatively uncomplicated. But for a mixed network containing SONET and SDH NEs, the timeslots for the protocols must be selected so that the appropriate information is carried in the appropriate timeslots. Conventionally, this is done by treating the SONET timeslot AID specifically and the SDH timeslot AID specifically. The information in the NE/NMS is very specific and very tightly coupled to the layer (SONET or SDH) information. This requires very careful and time-consuming assignment and translation of timeslots between the two protocols. A need arises for a technique by which the timeslots for the protocols are selected so that the appropriate information is carried in the appropriate timeslots transparently and automatically, and without the user having to worry about the underlying protocol (SONET/SDH).

### SUMMARY OF THE INVENTION

The present invention provides the capability to select the timeslots for the protocols so that the appropriate information is carried in the appropriate timeslots transparently and automatically, and without the user having to worry about the underlying protocol (SONET/SDH). The element specific information related to timeslots, such as timeslot AID and timeslot rate, in a SONET/SDH unified manner so that all the information related to timeslots is generic and not specifically related to SONET or SDH. This results in a smaller code base and a generic core computation that can be extended in the future to DWDM Network Elements.

In one embodiment of the present invention, a method of managing a telecommunications network comprises obtaining information relating to a physical termination point of the telecommunications network, obtaining information relating to a connection termination point of the telecommunications network, and generating a unique identifier for the connection termination point based on the obtained information relating to a physical termination point of the telecommunications network and the obtained information relating to a connection termination point of the telecommunications network. The unique identifier may be generated by obtaining a component ID of the connection termination point, converting the component ID to a plurality of numbers, and computing the unique identifier from the plurality of numbers.

In one aspect of the present invention, the connection termination point is a SONET connection termination point and the plurality of numbers include at least some of a first number representing an unchannelized (concatenation) STSnC (VC4) index for rates above an OC3/STM1 physical termination point rate or an STS1(VC) index for rates below an OC3/STM1 physical termination point rate, a second representing an STS3C (AUG) index, a third number representing an STS1(AUG-3) index within an AUG, a fourth number representing a VTG(TUG-12) group index, and a fifth number representing a VT(TU-12 or TU-11) index within the VTG (TUG-12) group.

In one aspect of the present invention, the connection termination point is an SDH connection termination point and the plurality of numbers include at least some of a first number representing an index for a connection termination point rate over VC4 or VC index if the physical termination point rate is below STM1, a second number representing an AU4 (STS3C) index, a third number representing an STS1 index within an AUG; a fourth number representing an VTG index, and a fifth number representing an VT index.

### BRIEF DESCRIPTION OF THE DRAWINGS

The preferred embodiments of the present invention will be described with reference to the accompanying drawings.

FIG. 1 is an exemplary block diagram of a telecommunications network in which the present invention may be implemented.

FIG. 2 is an exemplary flow diagram of a process for generating unique identifiers for each facility in a connection path, according to the present invention.

FIG. 3 is an exemplary listing of SONET/SDH components.

FIG. 4 is an exemplary diagram showing how a single SONET/SDH Timeslot can be represented by a combination of X, J, K, L, M numbers.

FIG. 5 is an exemplary diagram showing how a single SONET/SDH Timeslot can be represented by a combination of X, J, K, L, M numbers.

FIG. 6 is an exemplary diagram showing how a unique identifier can be computed from the individual SONET X, J, K, L, M numbers.

FIG. 7 is an exemplary diagram showing how a unique identifier can be computed from the individual SDH X, J, K, L, M numbers.

FIG. 8 is an exemplary diagram of obtaining the X, J, K, L, M Numbers from a unique identifier (represented by the number JKLM in the table) and the SONET/SDH CTP Rate, PTP Rate.

### DETAILED DESCRIPTION OF THE PREFERRED EMBODIMENTS

The present invention provides the capability to select the timeslots for the protocols so that the appropriate information is carried in the appropriate timeslots transparently and automatically, and without the user having to worry about the underlying protocol (SONET/SDH). The element specific information related to timeslots, such as timeslot AID and timeslot rate, in a SONET/SDH unified manner so that all the information related to timeslots is generic and not specifically related to SONET or SDH. This results in a smaller code base and a generic core computation that can be extended in the future to DWDM Network Elements.

The telecommunications network environment is best understood with reference to the following well-known terms:
CTP—Connection termination point (also referred to as timeslots in the document)
NE—Network Element
OC—Optical Carrier
PTP—Physical Termination Point (also referred to as facility in the document)
SDH—Synchronous Digital Hierarchy
SONET—Synchronous Optical Network
STM—Synchronous Transfer Mode
STS—Synchronous Transport Signal
TU—Transmit Unit
TUG—Transmit Unit Group
VC—Virtual Channel
VT—Virtual Tributary
VTG—Virtual Tributary Group

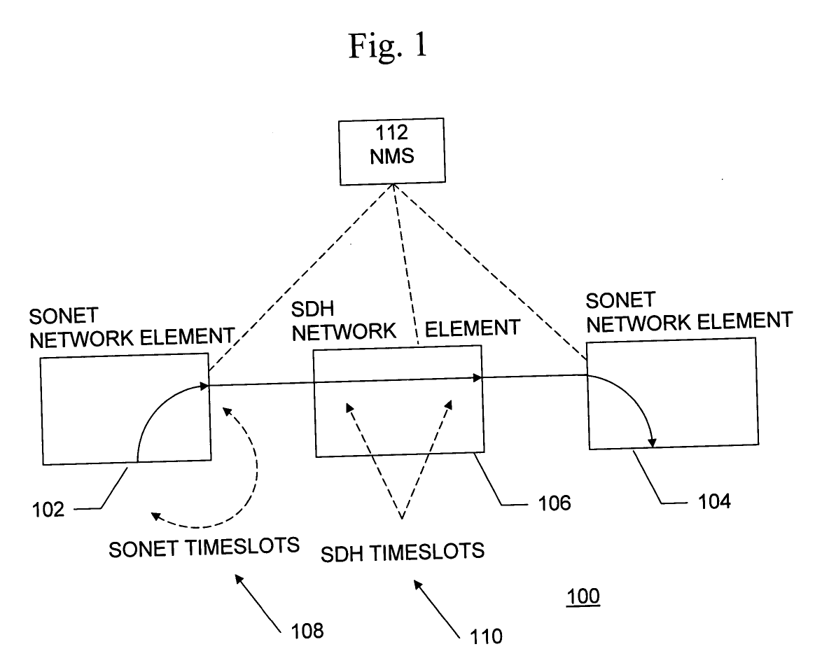

An example of a telecommunications network 100 in which the present invention may be implemented is shown in FIG. 1. Network 100 includes one or more SONET network elements 102 and 104, and one or more SDH network elements 106. SONET network element 102 carries telecommunications traffic in SONET timeslots 108, while SDH network element 106 carries telecommunications traffic in SDH timeslots 110. A Network Management System (NMS) 112 is configured to manage the network 100 that includes both SONET and SDH NEs. Each NE has different facilities and each facility has its own logical timeslots. In SONET NEs 102 and 104, SONET facilities have SONET timeslots 108 based on the bandwidth of the facility. Likewise, in SDH NE 106, SDH facility has SDH timeslots 110 based on the bandwidth of the facility. The SONET and SDH timeslots are not inherently related to each other.

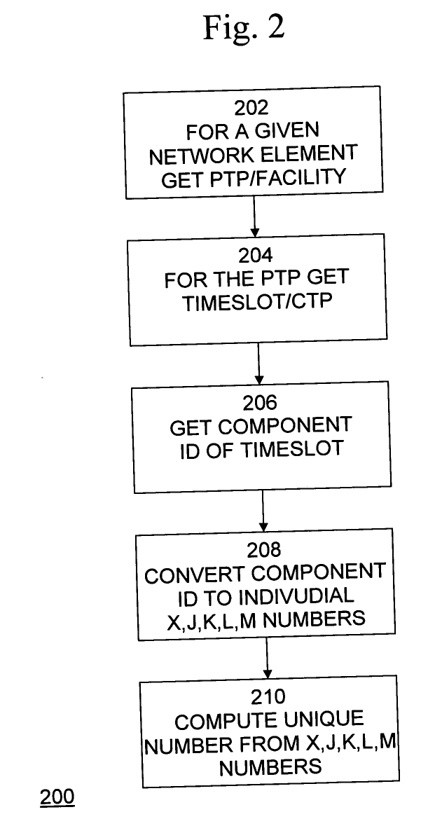

When creating connections for a user, the NMS 112 automatically selects the available timeslots for each facility in the connection path as shown in FIG. 2. FIG. 2 is a flow diagram of a process 200 for generating unique identifiers for each facility in a connection path, according to the present invention. Process 200 begins with step 202, in which, for a given NE, the Physical Termination Point (PTP) (also referred to as a facility) of the NE is obtained. Each PTP operates at a selected data rate. For example, the SONET PTP rates include OC192, OC48, OC12, OC3, EC1, etc., while, the SDH PTP Rates include STM64, STM16, STM4, STM1, etc. In step 204, for the obtained PTP, the Connection Termination Point (CTP) (also referred to as timeslots) are obtained. Each CTP operates at a selected data rate. For example, the SONET CTP rates include STS192C, STS48C, STS48B, STS12C, STS12B, STS3C, STS3B, STS1, VT1.5, etc. Thus, for example, For a SONET OC192 PTP, the CTP may have 192 (192/1) STS1 timeslots, 64 (192/3) STS3C Timeslots, 16 (192/12) STS12C Timeslots, 4 (192/48) STS48C Timeslots, or 1 (192/192) STS1 Timeslot.

In step 206, the component ID of the timeslot obtained in step 204 is obtained. In step 208, the component ID is converted to a plurality of numbers, termed X, J, K, L, and M. In step 210, a unique identifier for the timeslot is computed from the X, J, K, L, M numbers. This unique identifier may then be used to identify the timeslot throughout the entire network.

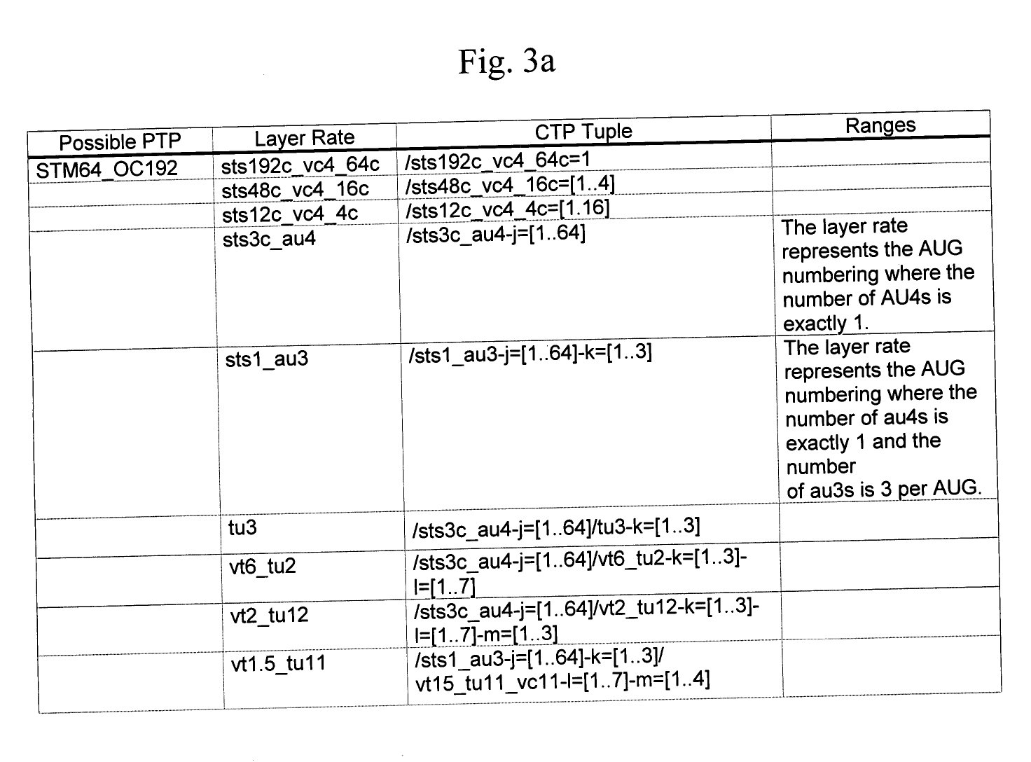

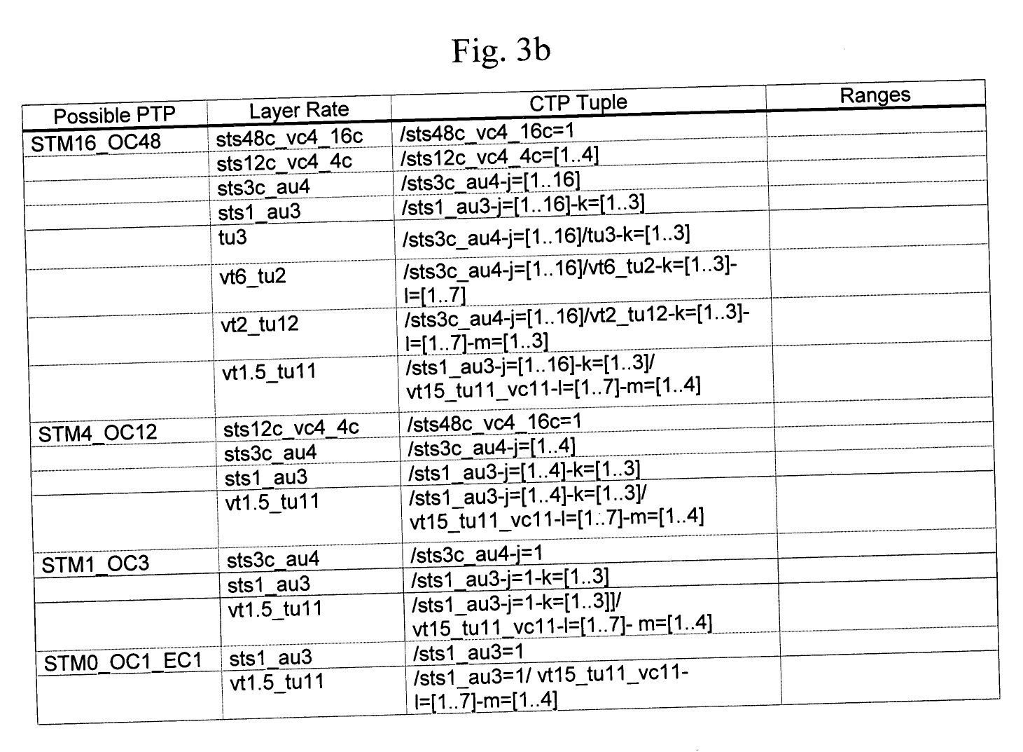

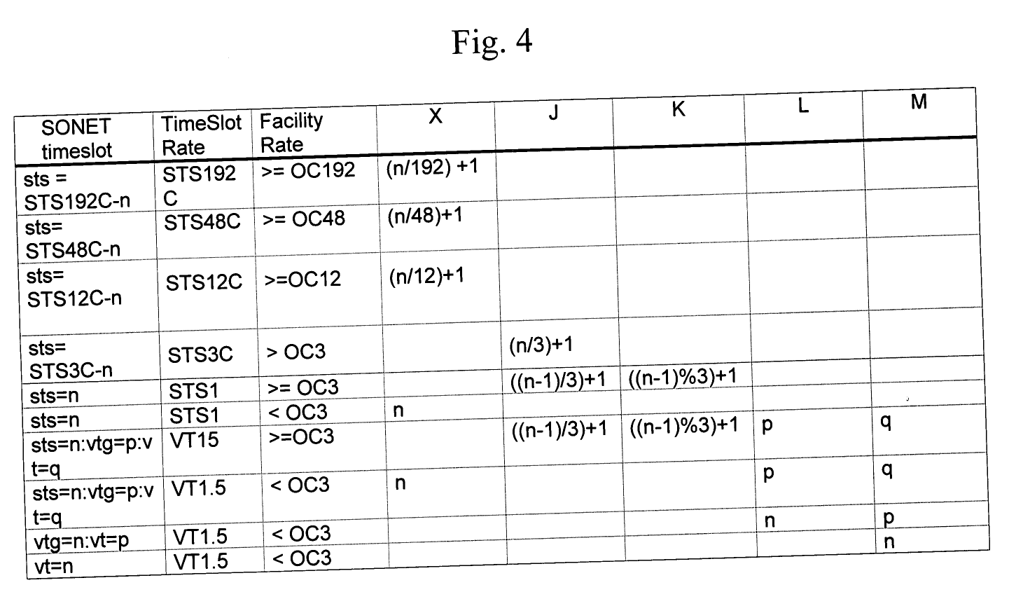

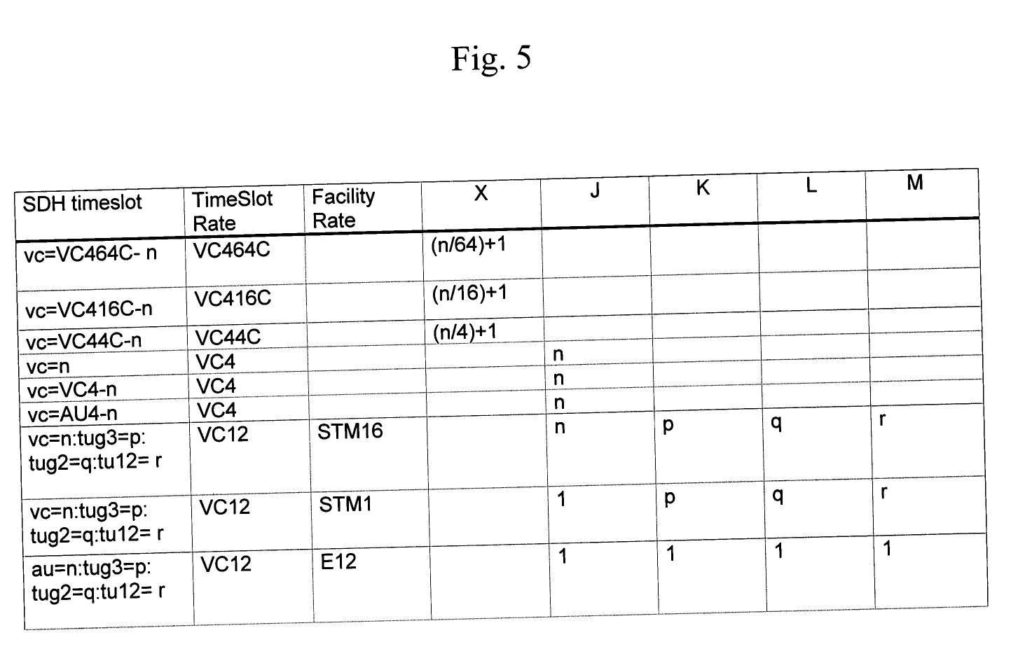

A listing of examples of the SONET/SDH Components is shown in FIGS. 3a and 3b. FIGS. 4 and 5 show examples of how a single SONET/SDH Timeslot can be represented by a combination of X, J, K, L, M numbers. The information for this table is derived from FIGS. 3a and 3b. The definitions of the X, J, K, L, M numbers for SONET mapping is:
X—the unchannelized (concatenation) STSnC (VC4) index (for above-OC3/STM1 PTP rate) or STS1(VC) index (for below-OC3/STM1 PTP rate)
J—the STS3C (AUG) index
K—the STS1(AUG-3) index within a AUG
L—the VTG(TUG-12) Group index
M—the VT(TU-12 or TU-11) index within the VTG (TUG-12) Group

For example, for a SONET CTP with a Component ID of shelf=MAINSHELF:slot=4:sts=5 and a facility rate of OC12, the corresponding XJKLM values are J=2, K=2 with X, L and M values undefined.

For example, for a SONET CTP with a Component ID of shelf=MAINSHELF:slot=4:sts=STS3C-7 and a facility rate of OC12, the corresponding XJKLM values are J=3 with X, K, L and M values undefined.

For example, for a SONET CTP with a Component ID of shelf-MAINSHELF:slot=4:sts=STS48C-49 and a facility rate of OC192, the corresponding XJKLM values are J=2 with X, K, L and M values undefined.

For example, for a SONET CTP with a Component ID of shelf=MAINSHELF:slot=4:sts=5:vtg=2:vt=3 and a facility rate of OC12, the corresponding XJKLM values are J=2, K=2, L=2, M=3 with X value undefined.

The definitions of the X, J, K, L, M numbers for SDH mapping is:
X—the index for Timeslot rate over VC4 or VC index if Facility rate is below STM1
J—the AU4 (STS3C) index
K—the STS1 index within an AUG
L—the VTG index
M—the VT index

For example, for a SDH CTP with a Component ID of group=2:vc=6 and facility rate of STM16, the corresponding XJKLM values are J=6 with X, K, L, and M values undefined.

For example, for a SDH CTP with a Component ID of group=1:vc=VC44C-9 and facility rate of STM16, the corresponding XJKLM values are X=3 with J, K, L and M values undefined.

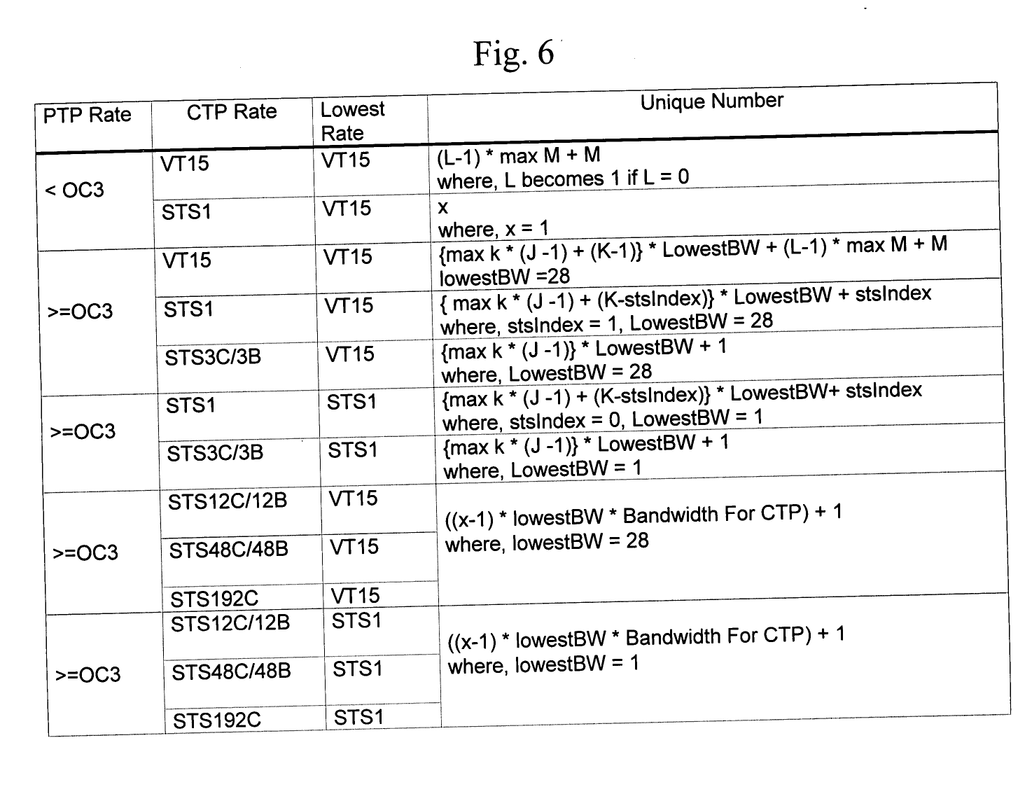

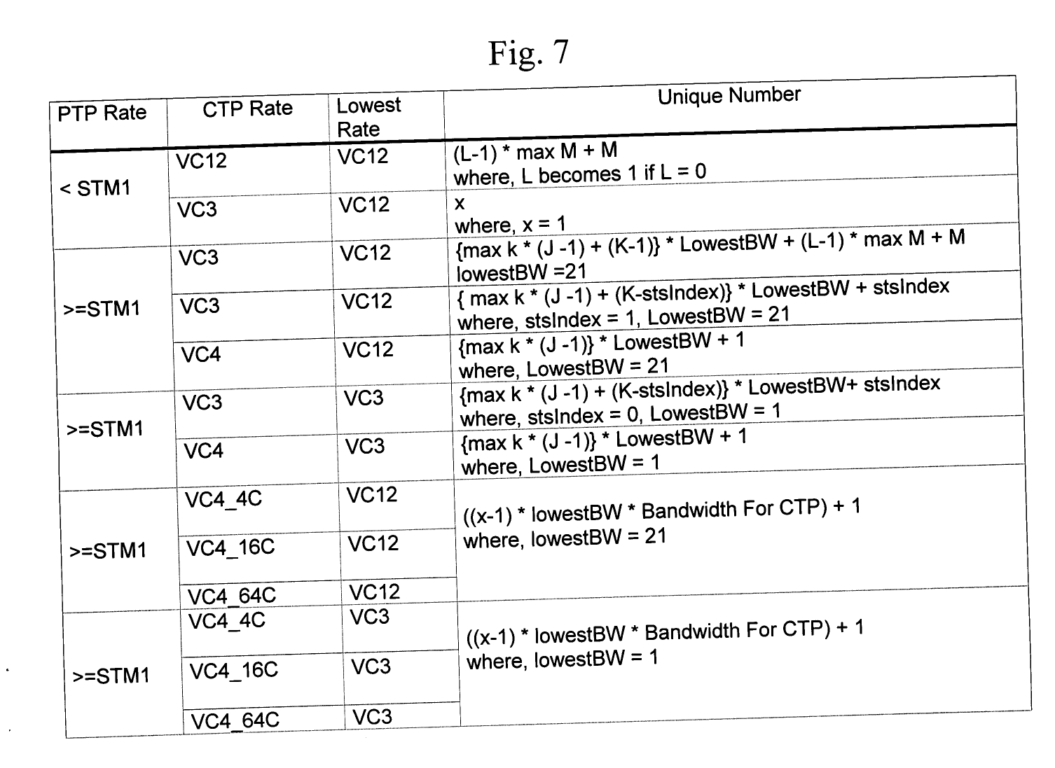

FIG. 6 and FIG. 7 shows examples of how, from the individual X, J, K, L, M numbers, a unique identifier can be calculated. This unique identifier is applicable for either a SONET or an SDH Timeslot. Every NE has facilities that correspond to the PTP. Each facility can have multiple timeslots at a SONET/SDH rate. For example, an OC12 facility can have 1 STS12C timeslot, 4 STS3C timeslots, 12 STS1 timeslots, or 12*28=336 VT15 timeslots. A timeslot at any of the above SONET Rates would correspond to a certain unique identifier. For example, an OC12 facility can have 12 STS1 Timeslots. The unique identifier of the timeslots will range from 1 to 12 at the STS1 Rate for the OC12 facility. It will range from 1 to 12 at increments of 3, i.e. 1, 4, 7, 10 at STS3C Rate for the OC12 facility. This number may be computed using FIG. 6, taking into consideration the facility rate, timeslot rate and the lowest possible timeslot rate for the facility. For example, for an OC3 facility, if the lowest possible timeslot rate is VT15 then there could be 28*3=84 timeslots at VT15 Rate. If the Timeslot rate is STS3C, then for a timeslot STS3C-4, the unique identifier would be 85 considering the lowest supported rate of VT15. This number may be computed from the X, J, K, L, M values using FIG. 6.

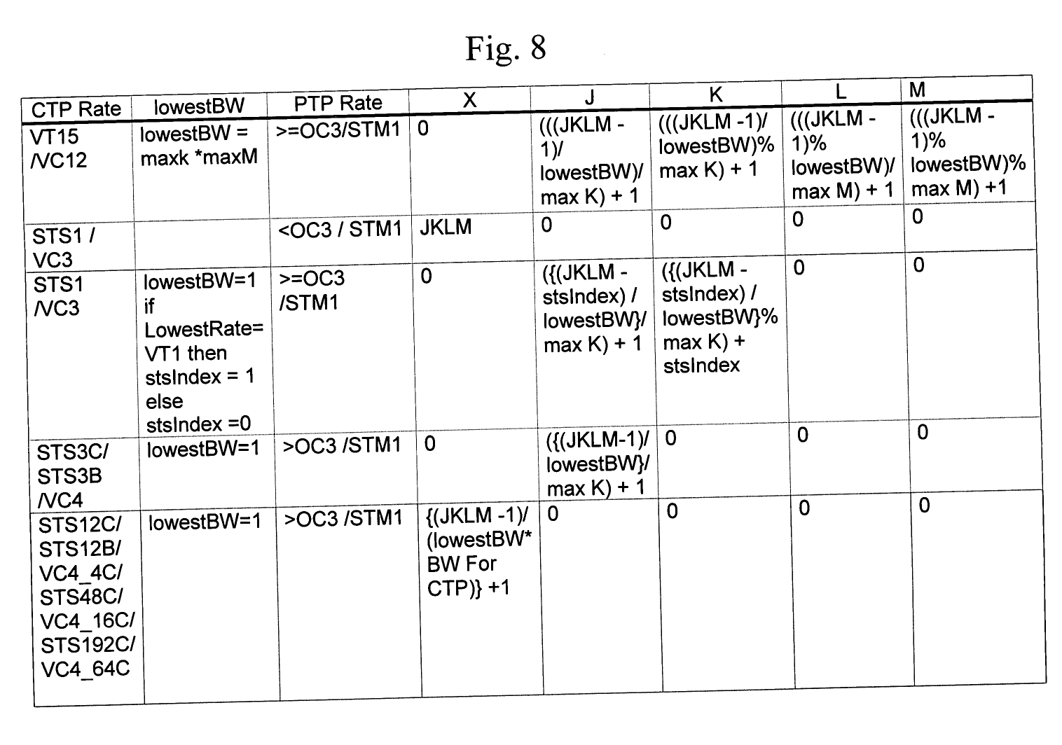

FIG. 8 shows examples of obtaining the X, J, K, L, M Numbers from a unique identifier given the CTP Rate, lowest Rate, and JKLM numbers.

The unique identifier computed using the individual X, J, K, L, M Numbers may then be used for Network Applications such Connection Management and Bandwidth Management. For example, if an OC12 facility has a lowest supported timeslot rate of STS1, then at the most it can have 12 STS1 timeslots worth of bandwidth. A bitset of 12 bits is formed. Then all cross-connects that start from or end at this facility are retrieved. For all the cross-connects the AID and rate are obtained. Using the AID and the rate of the cross-connect, the individual X, J, K, L, M Number are determined. Using these individual numbers, the unique identifier are determined using FIG. 6. This unique identifier would a number between 1 and 12. The bit position corresponding to unique identifier is set to 0, meaning it is not free for use by other circuits. When creating new circuits using an Automatic Connection Management application, the timeslots that already have cross-connects on them would not be used. The Bandwidth Management Application shows the percentage of a link between two facilities that is free to carry traffic. This percentage is determined by the number of timeslots that are free (no cross-connects) on both the facilities that are linked. All this computation is done generically and can be applied seamlessly to SONET or SDH facilities.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of managing a telecommunications network comprising:
obtaining information relating to a physical termination point of the telecommunications network;
obtaining information relating to a connection termination point of the telecommunications network; and
generating a unique identifier for the connection termination point based on the obtained information relating to a physical termination point of the telecommunications network and the obtained information relating to a connection termination point of the telecommunications network.

2. The method of claim 1, wherein the unique identifier is generated by:
obtaining a component ID of the connection termination point;
converting the component ID to a plurality of numbers; and
computing the unique identifier from the plurality of numbers.

3. The method of claim 2, wherein the connection termination point is a SONET connection termination point and the plurality of numbers include at least some of:
a first number representing an unchannelized (concatenation) STSnC (VC4) index for rates above an OC3/STM1 physical termination point rate or an STS1 (VC) index for rates below an OC3/STM1 physical termination point rate;
a second representing an STS3C (AUG) index;
a third number representing an STS1 (AUG-3) index within an AUG;
a fourth number representing a VTG (TUG-12) group index; and
a fifth number representing a VT (TU-12 or TU-11) index within the VTG (TUG-12) group.

4. The method of claim 2, wherein the connection termination point is an SDH connection termination point and the plurality of numbers include at least some of:
a first number representing an index for a connection termination point rate over VC4 or VC index if the physical termination point rate is below STM1;
a second number representing an AU4 (STS3C) index;
a third number representing an STS1 index within an AUG;
a fourth number representing an VTG index; and
a fifth number representing a VT index.

5. A system of managing a telecommunications network comprising:
a unit operable to obtain information relating to a physical termination point of the telecommunications network;
a unit operable to obtain information relating to a connection termination point of the telecommunications network; and
a unit operable to generate a unique identifier for the connection termination point based on the obtained information relating to a physical termination point of the telecommunications network and the obtained information relating to a connection termination point of the telecommunications network.

6. The system of claim 5, wherein the unique identifier is generated by:
a unit operable to obtain a component ID of the connection termination point;
a unit operable to convert the component ID to a plurality of numbers; and
a unit operable to compute the unique identifier from the plurality of numbers.

7. The system of claim 6, wherein the connection termination point is a SONET connection termination point and the plurality of numbers include at least some of:
a first number representing an unchannelized (concatenation) STSnC (VC4) index for rates above an OC3/STM1 physical termination point rate or an STS1 (VC) index for rates below an OC3/STM1 physical termination point rate;
a second representing an STS3C (AUG) index;
a third number representing an STS1 (AUG-3) index within an AUG;
a fourth number representing a VTG (TUG-12) group index; and
a fifth number representing a VT (TU-12 or TU-11) index within the VTG (TUG-12) group.

8. The system of claim 6, wherein the connection termination point is an SDH connection termination point and the plurality of numbers include at least some of:
a first number representing an index for a connection termination point rate over a VC4 or VC if the physical termination point rate is below STM1;
a second number representing an AU4 (STS3C) index;
a third number representing an STS1 index within an AUG;
a fourth number representing an VTG index; and
a fifth number representing a VT index.
